(19) United States
(12) Patent Application Publication
(10) Pub. No.: US 2008/0245184 A1
(43) Pub. Date: Oct. 9, 2008

(54) Preparation method of metal nano particle using micro mixer

(76) Inventors: Woo Ram Lee, Daejeon (KR); Jae Hoon Choe, Daejeon (KR); Jung Hyun Seo, Daejeon (KR); Yoo Seok Kim, Daejeon (KR)

Correspondence Address: MCKENNA LONG & ALDRIDGE LLP;Song K. Jung, 1900 K Street, N.W., Washington, DC, 20006, US

(21) Appl. No.: 11/812,072

(22) Filed: Jun. 14, 2007

(30) Foreign Application Priority Data
Jun. 15, 2006 (KR) 2006-53693

(51) Int. Cl. B22F 9/16; B01J 19/24; B22F 9/24

(52) U.S. Cl. 75/255; 75/371; 422/224; 977/777; 977/896

(57) ABSTRACT

Disclosed is a method for preparing metal nanoparticles, the method comprising the steps of: providing a solution of metal salt and a solution of a strong reducing agent with a standard reduction potential of −0.23V or lower; and mixing the solutions by using a micro mixer without supplying additional heat energy from the exterior, while carrying out reduction of the metal. Metal nanoparticles obtained by the above method, and a micro mixer for preparing the metal nanoparticles are also disclosed. The method for preparing metal nanoparticles via the reduction of metal ions in a solution uses a strong reducing agent and a micro mixer. Therefore, it is possible to obtain metal nanoparticles having a particle size of 20 nm or more and a uniform shape and dimension without supplying additional heat energy from the exterior. Additionally, the method is amenable to a continuous process, and thus ensures cost-efficiency and stable product quality required for mass production.

This application claims the benefit of the filing date of Korean Patent Application No. 2006-53693, filed on Jun. 15, 2006, in the Korean Intellectual Property Office, the disclosure of which is incorporated herein in its entirety by reference.

### TECHNICAL FIELD

The present invention relates to a method for preparing metal nanoparticles via the reduction of metal ions in a liquid phase.

### BACKGROUND ART

In general, nanoparticles have a nano-scaled particle size, show a so-called quantum confinement effect, followed by energy requirements for electronic transition varying with particle sizes, and have a large specific surface area. Thus, such nanoparticles show optical, electrical and magnetic properties different from those of the same material in a bulk state. Therefore, due to such properties, nanoparticles have been the focus of attention in terms of their applicability in the field of catalysts, electromagnetic science, optical science or medical science. It is thought that a nanoparticle is an intermediate between a bulk substance and a molecule. Two approaches, i.e. the “Top-down” approach and “Bottom-up” approach may be used to prepare nanoparticles. The “Top-down” approach includes crushing a bulk substance to obtain smaller particles, and is advantageous in that it allows easy control of the size of nanoparticles. However, the “Top-down” approach has a disadvantage of difficulty in preparing nanoparticles having a size of 50 nm or less. Therefore, the “Bottom-up” approach, including a step of assembling nanoparticles from the atomic or molecular level, has been spotlighted recently. According to the “Bottom-up” approach, nanoparticles are prepared frequently in a colloidal solution through a chemical molecular or atomic precursor.

Methods for preparing metal nanoparticles include a method for reducing metal ions with a reducing agent in a solution, a method using gamma rays, an electrochemical method, etc. However, conventional methods are problematic in that they have difficulty in preparing nanoparticles having a uniform size and shape, use an organic solvent leading to environmental pollution, and show low cost-efficiency. Moreover, such conventional methods adopt a high-temperature condition that may cause explosion, and the reactors used in such methods cannot be washed with ease after preparing the nanoparticles. Under these circumstances, it is difficult to obtain high-quality nanoparticles via a cost-efficient manner in a large scale.

The method for reducing metal ions with a reducing agent in a solution is a well-known method for preparing nanoparticles. However, reducing metal ions with a strong reducing agent makes it difficult to prepare metal nanoparticles having a uniform size and shape due to a rapid reaction in which the crystal growth rate cannot be easily controlled. Particularly, it is much more difficult to prepare larger particles having a size of 50 nm or more. Therefore, it has been attempted to use a weak reducing agent in order to control the reaction rate and to obtain uniform nanoparticles. However, the use of such weak reducing agents is not amenable to mass production. Particularly, ethylene glycol currently used as a reducing agent in such reactions has a high viscosity and low flow rate, and thus shows poor productivity in a continuous process.

### DISCLOSURE OF THE INVENTION

The inventors of the present invention have found that when a strong reducing agent and a micro mixer are used for preparing metal nanoparticles via the reduction of metal ions in a solution, it is possible to obtain metal nanoparticles having a size of 20 nm or more with no need for an additional energy supply from the exterior. By doing so, it is possible to obtain metal nanoparticles having a uniform size and shape despite the use of the strong reducing agent.

Therefore, it is an object of the present invention to provide a method for preparing metal nanoparticles via the reduction of metal ions in a solution by using a micro mixer, metal nanoparticles obtained by the same method, and a micro mixer for preparing metal nanoparticles.

In order to achieve the above-mentioned object, there is provided a method for preparing metal nanoparticles, the method comprising the steps of: providing a solution of metal salt and a solution of a strong reducing agent with a standard reduction potential of −0.23V or lower; and mixing the solutions by using a micro mixer without supplying additional heat energy from the exterior, while carrying out reduction of the metal. There is also provided metal nanoparticles obtained by the above method.

Further, there is provided a micro mixer for preparing metal nanoparticles, the micro mixer comprising: a first flow path through which a solution of metal salt is introduced; a second flow path through which a solution of a strong reducing agent with a standard reduction potential of −0.23V or lower is introduced; and a third flow path that is formed by the recombination of the first flow path with the second flow path, causes two or more fluids to be mixed by way of laminar flow diffusion, and allows the formation of metal nanoparticles via the reduction of metal ions and discharge of the resultant metal nanoparticles, while requiring no additional heat energy supply system.

### BRIEF DESCRIPTION OF THE DRAWINGS

FIG. 1 is a photographic view showing the Ag nanoparticles obtained by the method according to Example 1, taken by SEM (scanning electron microscopy).

FIG. 2 is a photographic view showing the Ag nanoparticles obtained by the method according to Comparative Example 1, taken by SEM (scanning electron microscopy).

FIG. 3 is a schematic view showing the micro mixer as disclosed herein.

### MODE FOR CARRYING OUT THE INVENTION

Hereinafter, the present invention will be explained in more detail.

The present invention is characterized by using a solution of a strong reducing agent with a standard reduction voltage of −0.23V or lower in a micro mixer for preparing metal nanoparticles so as to provide metal nanoparticles having a particle size of 20 nm or more and a uniform shape and dimension via a simple process with no need for an additional heat energy supply system, such as a heater.

In general, the solution process for preparing metal nanoparticles via the reduction of metal ions by adding a reducing agent to a solution containing the metal ions dissolved therein is carried out in a reactor provided with an agitator. Thus, the solution process is followed by circulation of the solution, resulting in formation of nuclei accompanied with growth thereof. Under these circumstances, it is difficult to obtain nano-sized monodispersed particles.

Meanwhile, a micro mixer has been generally used to form metal nanoparticles in a continuous process. In order to obtain metal nanoparticles having a uniform large size of 20 nm or more by using a mild or weak reducing agent, the reduction temperature should be controlled to a temperature ranging from 50° C. to 350° C., not room temperature. Therefore, an additional heat supply system is required under such conditions.

According to the present invention, a reducing agent with a standard reduction potential of −0.23V or lower is used in order to avoid a need for an additional heating system in a method for preparing metal nanoparticles using a micro mixer, and thus to obtain metal nanoparticles having a size of 20 nm or more even at a temperature ranging from 5° C. to 40° C. Such a reducing agent has very strong reducing power so that metal ions can be reduced at room temperature without supplying any additional heat energy.

A micro mixer causes a solution of metal salt and a solution of reducing agent to be in contact with each other in the form of laminar flow, so that they are diffused on the interfacial surface. In the micro mixer, each flow path has a very small diameter and provides a relatively large contact area versus the volume of the reactants, thereby inducing uniform mixing and reaction. Therefore, such laminar flow contact between the solution of metal salt and the solution of reducing agent allows uniform reduction of the metal ions, and thus provides a dispersion in which the metal nanoparticles having a uniform size and shape are dispersed.

Particles are formed via the steps of formation of nuclei and growth of nuclei.

During the formation of metal particles, a solution containing metals becomes over-saturated according to the reduction of the metal ions. When the over-saturation degree increases continuously and reaches the critical concentration, formation of nuclei proceeds. Then, the metal particles are precipitated and the over-saturation degree decreases so that nuclei cannot be formed any longer, while the existing nuclei grow continuously until the over-saturation degree decreases to the equilibrium concentration of the system.

When the metal ions show a high reduction rate, driving force for inducing formation of nuclei increases, resulting in an increase in the number of nuclei formed from the metal ions. Therefore, a strong reducing agent provides a higher reduction rate as compared to a weak reducing agent, and thus facilitates active formation of nuclei even at a temperature ranging from 5° C. to 40° C. (including room temperature). Meanwhile, the formation of particles with a uniform size requires instantaneous formation of nuclei caused by the consumption of an excessive amount of solute at once. Such instantaneous formation of nuclei can be maximized when a strong reducing agent is used in a micro mixer based on laminar flow mixing.

Meanwhile, when using a strong reducing agent with a standard reduction potential of −0.23V or lower, turbulence mixing or heating, other than laminar flow mixing in a micro mixer, may result in an excessively high reduction rate and an increase in the number of formed nuclei. This causes a drop in the concentration of reactants for growth of nuclei, so that the resultant particles have a small size.

Therefore, according to the present invention, a strong reducing agent capable of providing strong reducing power at room temperature is used to allow the formation of nuclei at room temperature. Additionally, a micro mixer capable of laminar flow mixing is used in combination with the strong reducing agent in order to inhibit a rapid reduction by controlling the reduction rate. As a result, the method according to the present invention makes it possible to grow metal nanoparticles to a size of 20 nm or more.

### <Method for Preparing Metal Nanoparticles Using Micro Mixer>

There is no particular limitation in the nanoparticles obtained by the method according to the present invention, as long as the nanoparticles are metal nanoparticles that can be obtained via the reduction of metal ions in a solution. Non-limiting examples of the metal include noble metals, such as Au, Ag, Pt or Pd, and transition metals, such as Co, Ni or Fe.

In the method according to the present invention, there is no particular limitation in the metal salt used in the first step, as long as the metal salt can be ionized in a solution to provide metal ions. The metal salt may be one known to those skilled in the art, and non-limiting examples thereof include metal nitrates (NO₃⁻), metal halides (Cl⁻, Br⁻, I⁻), metal oxyhydrates (OH⁻), metal sulfates (SO₄²⁻), or the like.

In the method according to the present invention, the reducing agent used in the first step is a strong reducing agent with a standard reduction potential of −0.23V or lower. There is no particular limitation in the reducing agent, as long as the reducing agent can perform reduction of metal ions dissolved in a solution to allow precipitation of metal particles, and has such strong reducing power at room temperature. The reducing agent may be one known to those skilled in the art, and non-limiting examples thereof include NaBH₄, NH₂NH₂, LiAlH₄, LiBEt₃H, etc. The strong reducing agent used in the method according to the present invention may have a standard reduction potential of −2˜−0.23V.

If a weak reducing agent is used, it provides a low reaction rate and requires a post-heating step. Thus, such weak reducing agents are not amenable to a continuous process, and are not suitable for mass production. Particularly, if ethylene glycol, a kind of weak reducing agent, is used, it shows high viscosity followed by a low flow rate, and thus provides undesirably low productivity in a continuous process.

Therefore, a strong reducing agent is preferable for preparing metal nanoparticles via the reduction of metal ions in a solution in a large-scale continuous process suitable for mass production. There has been difficulty in controlling the size and shape of particles in the presence of a strong reducing agent for reducing metal ions. This is because such strong reducing agents cause a rapid reaction. On the contrary, the method according to the present invention utilizes a micro mixer to induce uniform mixing and reaction. Thus, it is possible to obtain metal nanoparticles with a uniform size and shape even in the presence of the strong reducing agent.

Additionally, the micro mixer allows the application of a continuous process rather than a batch process. Therefore, when the method according to the present invention is applied to mass production of metal nanoparticles, it is expected that the reaction rate can be improved by the use of the strong reducing agent and the productivity can be also improved.

In the micro mixer, two of more kinds of fluids are mixed in flow paths having a very small diameter, so as to provide a relatively large contact area versus the volumes of the reactants. Thus, the micro mixer is advantageous in that it can induce uniform mixing and reaction.

In the method according to the present invention, the solvent used in the first step may include water, an organic solvent, or a mixed solvent of water with an organic solvent. Preferably, water is used as the solvent. The use of water is advantageous in terms of cost efficiency, workability and effects on the environment. Despite such advantages of water as a solvent, organic solvents have been frequently used to date due to their advantages in preparing uniform particles. However, the method according to the present invention ensures uniform mixing of reactants even in an aqueous solution by using the micro mixer, and thus allows preparation of particles having a uniform size and shape.

Preferably, the metal ions are present in a concentration of 10⁻⁶ mol/L˜1 mol/L in the solution and the reducing agent is used in a concentration of 10⁻⁶ mol/L˜1 mol/L in the solution.

In the method according to the present invention, additives, such as a dispersant, may be further added to the solution. The dispersant that may be used in the present invention includes a polymer or a single molecule ligand, and non-limiting examples thereof include PVP (poly (N-vinyl pyrrolidone)), PVA (polyvinyl alcohol), sorbitol, urea, etc.

The method according to the present invention is characterized by mixing the solutions prepared in the first step in a micro mixer. There is no particular limitation in the micro mixer, as long as the micro mixer is known to induce mixing and reaction between micro-fluids. Preferably, the micro mixer is the micro mixer for preparing metal nanoparticles according to the present invention.

The micro mixer is a mixing system based on continuous type laminar flow diffusion rather than batch type turbulence mixing. The micro mixer includes long flow paths having a width of several millimeters or less and disposed suitably in a small mixer, so that two or more solutions supplied thereto are mixed via the diffusion into each other while passing through the flow paths.

The solution of metal salt and the solution of reducing agent are mixed uniformly by the micro mixer, while causing reduction of the metal ions. For example, Ag⁺ ions are reduced into Ag⁰ metal particles by NaBH₄, and the nano-sized Ag metal particles can be dispersed uniformly in the solution.

Meanwhile, the metal nanoparticles obtained by the method according to the present invention have a particle size of 20 nm˜200 nm, and preferably of 50 nm˜100 nm. Metal nanoparticles obtained by the conventional method of reducing metal ions have a small particle size and are not uniform. On the contrary, the metal nanoparticles obtained by using the micro mixer according to the present invention have a relatively large particle size in the range as described above and are uniform particles.

<Micro Mixer for Preparing Metal Nanoparticles>

The present invention also provides a micro mixer for preparing metal nanoparticles by the method for preparing metal nanoparticles via the reduction of metal ions in a solution according to the present invention.

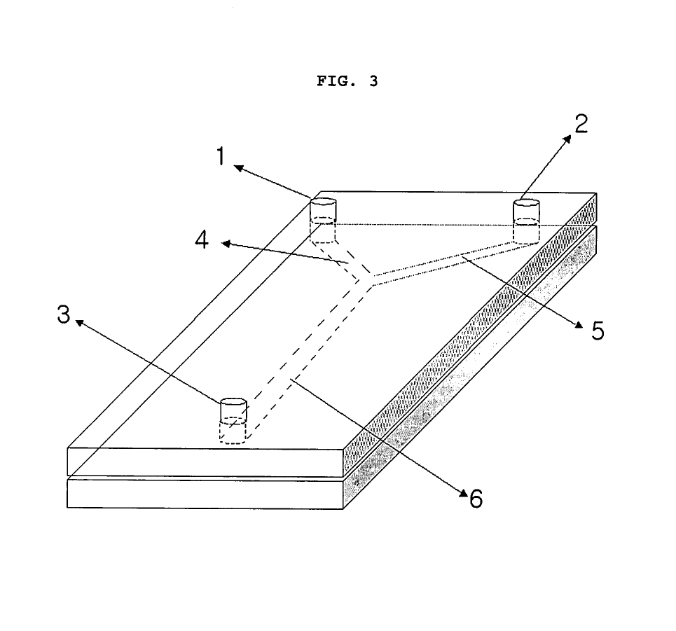

FIG. 3 is a schematic view showing a preferred embodiment of the micro mixer according to the present invention. The micro mixer for preparing metal nanoparticles comprises a first flow path through which a solution of metal salt is introduced, and a second flow path through which a solution of a strong reducing agent with a standard reduction potential of −0.23V or lower is introduced. The first flow path and the second flow path are recombined with each other at a certain point in the micro mixer to form a third flow path. In the third flow path, the two or more fluids can be uniformly mixed and subjected to a reaction via the laminar flow diffusion. The resultant product is discharged out of a discharge port.

The first flow path, the second flow path and the third flow path may be formed of various materials including stainless steel, ceramics, glass, polymeric materials, etc. However, the scope of the present invention is not limited to the above materials.

The first flow path, the second flow path and the third flow path each have a diameter of 10⁻² mm˜5 mm and a length of 5 mm˜1000 mm. The third flow path has a linear shape but is not limited thereto. The third flow path may include at least one gently bent portion and/or sharply bent portion therein, and may have a predetermined shape for inducing mixing of the reactants. Additionally, at least one baffle may be disposed in the third flow path to cause turbulence in a predetermined portion. However, there is no particular limitation in the shape of the flow path, the shape of the baffle or their sizes.

The solution of metal salt and the solution of reducing agent introduced through the first flow path and the second flow path, respectively, are in contact with each other through the micro-size third flow path, form laminar flows, and cause diffusion on the interface between them. If such laminar flow diffusion occurs in a conventional macro-scale flow path or reactor, it cannot be ensured that the reactants are uniformly mixed and reacted, due to the local reaction. However, in the micro mixer according to the present invention, the flow paths have a very small diameter and provide a relatively large contact area versus the volumes of the reactants, thereby inducing uniform mixing and reaction. Therefore, the solution of metal salt and the solution of reducing agent mixed in the third flow path can induce uniform reduction of the metal ions, and thus can provide a dispersion in which metal nanoparticles having a uniform shape and size are dispersed.

Herein, the shape and size of the particles can be controlled depending on the flow rates, concentrations of the metal salt and the reducing agent, concentration of a dispersion stabilizer, or the like.

The flow rate in each of the first flow path, the second flow path and the third flow path may range from 1 ml/min. to 100 ml/min.

The third flow path is connected to the discharge port for discharging the product, so that the reaction product (i.e. dispersion of metal nanoparticles) obtained from the mixing and reaction in the third flow path can be discharged therethrough. In this way, the method according to the present invention is amenable to a continuous process.

To form a fluid flow in the micro mixer, the micro mixer may be further provided with a pump for feeding a fluid into an inlet of the first flow path and/or the second flow path, or a pump for drawing the reaction product at the discharge port connected to the third flow path,

Reference will now be made in detail to the preferred embodiments of the present invention. It is to be understood that the following examples are illustrative only and the present invention is not limited thereto.

### EXAMPLE 1

First, 0.25 g of AgNO₃ and 1 g of PVP (average molecular weight: 55,000) were dissolved in 50 ml of water to provide an aqueous Ag solution. Next, 0.018 g of NaBH₄ was dissolved in 50 ml of water to provide an aqueous solution of reducing agent. The two solutions were injected into a caterpillar split-recombine micro mixer (COMM-R600 available from IMM Co.) individually at a rate of 22 ml/min. to perform a reaction. After the reaction, the resultant dispersion was washed with acetone twice and filtered to provide Ag nanoparticles.

FIG. 1 is a photographic view showing the Ag nanoparticles taken by SEM. The Ag nanoparticles had an average particle size of 78.6 nm and showed a standard deviation in the particle sizes of 15.5 nm (19.7%). It can be seen from the above results that the Ag nanoparticles obtained by the method according to the present invention have a relatively large particle size and a uniform shape and dimension (standard deviation<20%). As compared to the following Comparative Example 1, generation of a plurality of dispersed seed particles is inhibited and a growth mechanism of particles is prominent, resulting in an increase in the particle size.

### COMPARATIVE EXAMPLE 1

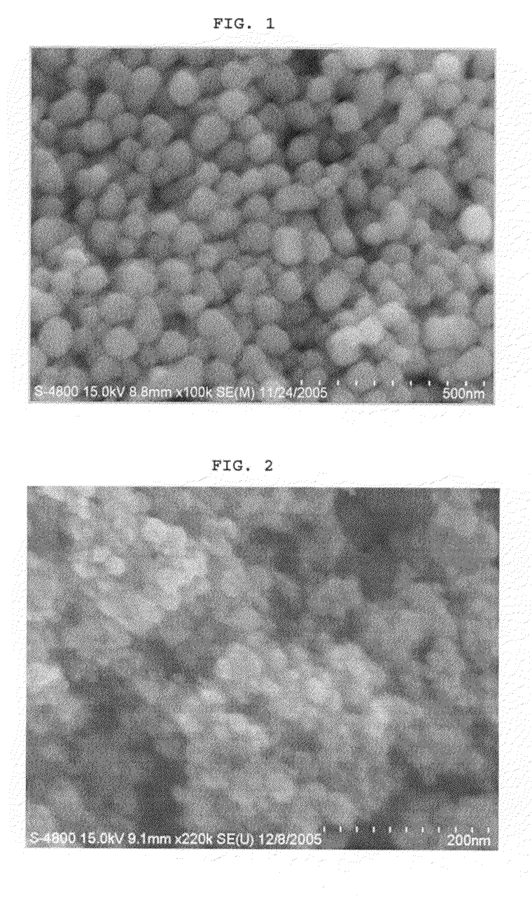

To a flask containing 0.5 g of AgNO₃ and 2 g of PVP (average molecular weight 55,000) dissolved in 20 ml of distilled water, a solution of reducing agent containing 0.35 g of NaBH₄ dissolved in 20 ml of distilled water was gradually added dropwise through a dropping funnel to perform a reaction. After the reaction, the resultant dispersion was washed with acetone twice and filtered to provide Ag nanoparticles. As shown in FIG. 2, the Ag nanoparticles have a small particle size and are not uniform.

### INDUSTRIAL APPLICABILITY

As can be seen from the foregoing, the method for preparing metal nanoparticles via the reduction of metal ions in a solution according to the present invention uses a strong reducing agent and a micro mixer. According to the method of the present invention, it is possible to obtain metal nanoparticles having a particle size of 20 nm or more and a uniform shape and dimension without supplying additional heat energy from the exterior. Additionally, the method according to the present invention is amenable to a continuous process, and thus ensures cost-efficiency and stable product quality required for mass production.

Although several preferred embodiments of the present invention have been described for illustrative purposes, those skilled in the art will appreciate that various modifications, additions and substitutions are possible, without departing from the scope and spirit of the invention as disclosed in the accompanying claims.

1. A method for preparing metal nanoparticles, the method comprising the steps of:
providing a solution of metal salt and a solution of a strong reducing agent with a standard reduction potential of −0.23V or lower; and
mixing the solutions by using a micro mixer without supplying additional heat energy from the exterior, while carrying out reduction of the metal.

2. The method as claimed in claim 1, wherein the metal nanoparticles have a size of 20 nm˜200 nm.

3. The method as claimed in claim 1, wherein the metal is at least one metal selected from the group consisting of noble metals and transition metals.

4. The method as claimed in claim 1, wherein the metal salt is at least one selected from the group consisting of metal nitrates, metal halides, metal oxyhydrates and metal sulfates.

5. The method as claimed in claim 1, wherein the strong reducing agent is capable of inducing reduction of the metal at a temperature of 5˜40° C.

6. The method as claimed in claim 1, wherein the solution of reducing agent includes at least one reducing agent selected from the group consisting of NaBH₄, NH₂NH₂, LiAlH₄ and LiBEt₃H.

7. The method as claimed in claim 1, wherein the solution of metal salt comprises the metal ions in a concentration of 10⁻⁶ mol/L˜1 mol/L, and the solution of reducing agent comprises the reducing agent in a concentration of 10⁻⁶ mol/L˜1 mol/L.

8. The method as claimed in claim 1, wherein the solution of metal salt and the solution of reducing agent each are independently provided as an aqueous solution.

9. The method as claimed in claim 1, wherein the solution of metal salt and the solution of reducing agent each further comprise a dispersion stabilizer.

10. A micro mixer for preparing metal nanoparticles, the micro mixer comprising:
a first flow path through which a solution of metal salt is introduced;
a second flow path through which a solution of a strong reducing agent with a standard reduction potential of −0.23V or lower is introduced; and
a third flow path that is formed by the recombination of the first flow path with the second flow path, causes two or more fluids to be mixed by way of laminar flow diffusion, and allows formation of metal nanoparticles via the reduction of metal ions and discharge of the resultant metal nanoparticles, and having no additional heat energy supply system.

11. The micro mixer as claimed in claim 10, wherein the metal nanoparticles have a size of 20 nm˜200 nm.

12. The micro mixer as claimed in claim 10, wherein the third flow path has a diameter of 10⁻² mm˜5 mm and a length of 5 mm˜1000 mm.

13. The micro mixer as claimed in claim 10, wherein the solution of metal salt and the solution of reducing agent each are independently provided as an aqueous solution.

14. The micro mixer as claimed in claim 10, wherein the metal is at least one metal selected from the group consisting of noble metals and transition metals; and the metal salt is at least one selected from the group consisting of metal nitrates, metal halides, metal oxyhydrates and metal sulfates.

15. The micro mixer as claimed in claim 10, wherein the strong reducing agent is capable of inducing reduction of the metal at a temperature of 5˜40° C.

16. The micro mixer as claimed in claim 1, wherein the solution of the reducing agent includes at least one reducing agent selected from the group consisting of NaBH₄, NH₂NH₂, LiAlH₄ and LiBEt₃H.

17. The micro mixer as claimed in claim 10, which allows the resultant reaction product to be recovered continuously.

18. The micro mixer as claimed in claim 10, wherein a fluid has a flow rate of 1 ml/min.˜100 ml/min. in the first flow path, the second flow path and the third flow path.

19. Metal nanoparticles obtained by the method as defined in claim 1 and having a particle size of 20 nm˜200 nm.
